(19) United States
(12) Patent Application Publication
(10) Pub. No.: US 2014/0233138 A1
(43) Pub. Date: Aug. 21, 2014

(54) GROUND FAULT CIRCUIT INTERRUPTER

(71) Applicant: DELPHI TECHNOLOGIES, INC., Troy, MI (US)

(72) Inventor: RONALD J. GLIEBE, MENTOR, OH (US)

(73) Assignee: DELPHI TECHNOLOGIES, INC., TROY, MI (US)

(21) Appl. No.: 13/768,063

(22) Filed: Feb. 15, 2013

(51) Int. Cl. H02H 3/16

(52) U.S. Cl. CPC H02H 3/162
USPC 361/45

(57) ABSTRACT

A ground fault circuit interrupter (GFCI) includes a sense coil to determine a current flow in a power circuit coupled between a power source and a load. The GFCI also includes a switching device configured to disconnect the power source from the load. The GFCI further includes a controller that controls the switching device based on the current flow in the power circuit. The GFCI additionally includes an electrical power supply that provides electrical power to the switching device. The power supply is electrically separate and isolated from the power circuit. The GFCI may be used to monitor a power circuit connected to a tuned resonant circuit, such as a source or capture resonator of a wireless power transfer system, since inductive elements in the switching device, such as solenoids, are isolated from the power circuit and therefore cannot unbalance a tuned resonant circuit connected to the power circuit.

### TECHNICAL FIELD OF THE INVENTION

The invention generally relates to a ground fault circuit interrupter (GFCI), and more particularly relates to a GFCI suitable for use with a wireless energy transfer system.

### BACKGROUND OF THE INVENTION

Wireless electrical energy transfer systems are known to incorporate a first resonator structure (source resonator) that includes a tuned resonant circuit configured to convert electrical energy to magnetic energy and to transfer the magnetic energy to a spaced apart second resonator structure (capture resonator). The capture resonator also includes a tuned resonant circuit configured for receiving the wirelessly transmitted magnetic energy and converting the magnetic energy to electrical energy. Such a wireless energy transfer system may be used for electrically charging an energy storage device, such as battery of an electric or hybrid electric vehicle. In such a system, the source resonator may be located on, or embedded into, a surface for example the floor of a garage or the surface of a parking lot, and the capture resonator may be disposed on a vehicle.

In such an electrical energy transfer system, potential hazards exist if the electrical energy finds an undesirable path to ground. Ground fault circuit interrupter (GFCI) devices may be used detect and correct this condition. The circuitry of the GFCI (e.g. a controller and a switching device) is typically powered by the circuit that is protected by the GFCI.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

The inventor recognized that a ground fault circuit interrupter (GFCI) connected to a tuned resonant circuit of a capture resonator or a source resonator may cause the tuned resonant circuit to be unbalanced due to inductive components in the circuitry of the GFCI (e.g. a switching device having a solenoid, such as a circuit breaker or mechanical relay) when the circuitry of the GFCI is powered by the circuit that includes the circuit protected by the GFCI, e.g. including the tuned resonant circuit. Therefore, the present invention includes a GFCI that has a power supply that provides power to the switching device that is electrically separate and electrically isolated from the circuit that is protected by the GFCI.

In accordance with one embodiment of this invention, an electrical GFCI device is provided. The GFCI device includes a sense coil configured to determine a current flow in an electrically conductive power circuit that is coupled between a power source and a load. The GFCI device also includes a switching device that is coupled to the power circuit and is configured to disconnect the power source from the load. The GFCI device further includes a controller that is in communication with the sense coil and the switching device. The GFCI is configured to control the switching device based on the current flow in the power circuit. The GFCI device additionally includes an electrical power supply that is coupled to the switching device. The power supply is electrically separate and electrically isolated from the power circuit.

The power source may be a tuned resonant circuit and that tuned resonant circuit may be a capture resonator of a wireless energy transfer system. The load may be a tuned resonant circuit and that tuned resonant circuit may be a source resonator of the wireless energy transfer system. The controller may be configured to control the switching device to reconnect the power source to the load after the switching device disconnects the power source from the load.

In another embodiment of the present invention, a wireless power transmitter is provided. The wireless power transmitter includes a power source, a source resonator, an electrically conductive power circuit coupled between the power source and the source resonator, and a GFCI device. The GFCI device includes a sense coil that is configured to determine a current flow in the power circuit. The GFCI device also includes a switching device that is coupled to the power circuit and configured to disconnect the power source from the load. The GFCI device further includes a controller that is in communication with the sense coil and the switching device. The GFCI is configured to control the switching device based on the current flow in the power circuit. The GFCI device additionally includes an electrical power supply that is coupled to the switching device. The power supply is electrically separate and electrically isolated from the power circuit.

The source resonator may be a tuned resonant circuit. The controller may be configured to control the switching device to reconnect the power source to the source resonator after the switching device disconnects the power source from the source resonator.

In yet another embodiment of the present invention, a wireless power receiver is provided. The wireless power receiver includes a capture resonator, an electrical storage device, an electrically conductive power circuit coupled between the capture resonator and the storage device, and a GFCI device. The GFCI device includes a sense coil configured to determine a current flow in the power circuit. The GFCI device also includes a switching device that is coupled to the power circuit and is configured to disconnect the power source from the load. The GFCI device further includes a controller that is in communication with the sense coil and the switching device. The GFCI is configured to control the switching device based on the current flow in the power circuit. The GFCI device additionally includes an electrical power supply coupled to the switching device. The power supply is electrically separate and electrically isolated from the power circuit.

The capture resonator may be a tuned resonant circuit. The controller may be configured to control the switching device to reconnect the capture resonator to the storage device after the switching device disconnects the capture resonator from the storage device.

Further features and advantages of the invention will appear more clearly on a reading of the following detailed description of the preferred embodiment of the invention, that is given by way of non-limiting examples only and with reference to the accompanying drawings.

### BRIEF DESCRIPTION OF THE SEVERAL VIEWS OF THE DRAWING

The present invention will now be described, by way of example with reference to the accompanying drawings, in which:

FIG. 1 is block diagram of a wireless electrical energy transfer system including a ground fault circuit interrupter (GFCI) in accordance with one embodiment;

FIG. 2 is schematic diagram of a GFCI in accordance with one embodiment; and

FIG. 3 is schematic diagram of a GFCI in accordance with another embodiment.

### DETAILED DESCRIPTION OF INVENTION

A ground fault circuit interrupter (GFCI) device monitors the flow of electrical current in an electrically conductive power circuit. An imbalance in the flow of current through the power circuit indicates that some amount of current is flowing in a path outside the intended path of the power circuit. This is an undesirable condition that is commonly referred to as a ground fault. When this ground fault condition is detected, a switching device in the GFCI will open circuit the power circuit to stop the flow of current.

The switching device may contain coils, such as a circuit breaker trip solenoid or relay solenoid, that have an inductance. If the GFCI is used in a power circuit that includes a tuned resonant circuit, such as a source resonator or capture resonator of a wireless power transfer system, the inductance of the coil in the GFCI could unbalance the tuned resonant circuit if it is not electrically isolated from the tuned resonant circuit. The GFCI power supply described herein provides the benefit of electrically isolating and separating the switching device from the power circuit and hence isolate a tuned resonant circuit connected to the power circuit from the switching device.

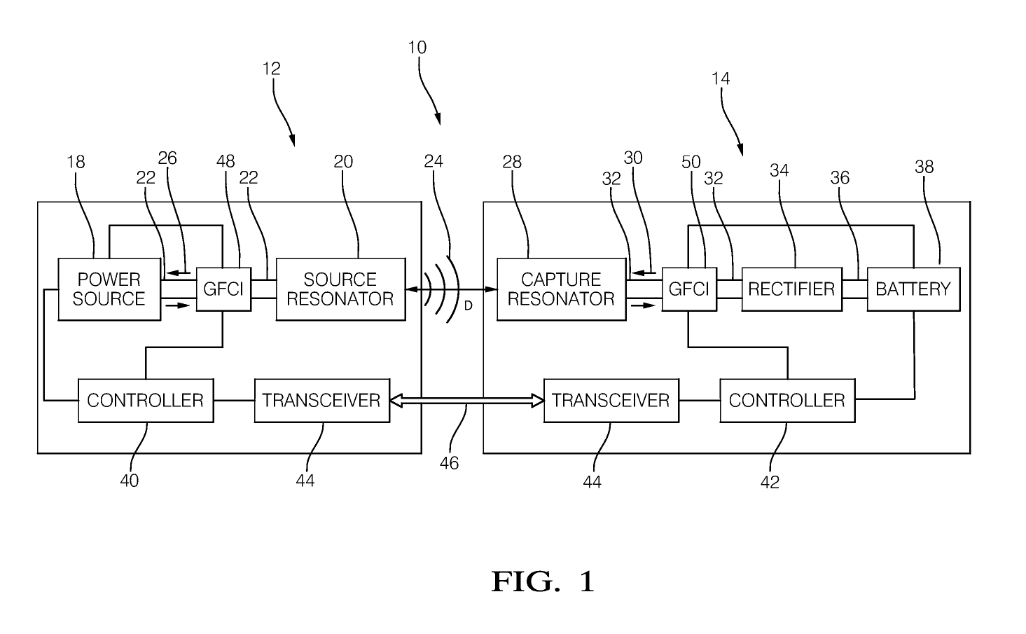

FIG. 1 illustrates a non-limiting example of a wireless energy transfer system 10 that may be used to wirelessly transfer electrical energy, for example from a battery charging station to an electric vehicle. The wireless energy transfer system 10 in this example has two parts, a wireless power transmitter 12 and a wireless power receiver 14. The wireless power transmitter 12 could be a stationary wireless charging station for an electric vehicle and the wireless power transmitter 12 could be a wireless battery charging system disposed in an electric or hybrid electric vehicle. The wireless power transmitter 12 includes a power source 18, such as an alternating current (AC) power supply connected to a power supply grid (not shown), such as a public electric utility. The power source 18 typically outputs electrical power at a higher voltage and frequency than that provided by the power supply grid, for example at 300 Volts (VAC) and 145 kilohertz (kHz). The power source 18 is connected to a source resonator 20 by an electrically conductive first power circuit 22. The first power circuit 22 comprises of a pair of insulated, but unshielded, wires formed of a conductive material, such as a copper-based or aluminum-based material. The source resonator 20 includes a tuned resonant circuit (not shown) that is configured to transmit magnetic energy 24 when excited by a first alternating electric current 26 flowing from the power source 18 to the source resonator 20 through a first power circuit 22 at a frequency at or near the resonant frequency of the source resonator 20. The wireless power transmitter 12 also includes a GFCI 48 configured to open the first power circuit 22 if a ground fault in the first power circuit 22 is detected.

The wireless power receiver 14 includes a capture resonator 28 that is configured to be located a distance D from the source resonator 20. The capture resonator 28 also includes a tuned resonant circuit (not shown) that is excited by the magnetic energy 24 transmitted by the source resonator 20 and produces a second alternating electric current 30 that flows through a second power circuit 32. The second power circuit 32 is connected to a rectifier circuit 34 that converts the second alternating current to a direct current that flows through a third power circuit 36 to an electric storage device 38, such as a battery 38. The wireless power receiver 14 also includes a GFCI 50 configured to open the second power circuit 32 if a ground fault in the second power circuit 32 is detected. The first GFCI 48 and the second GFCI 50 may be of the same design or they may be of different designs. GFCI 48 and GFCI 50 may be the GFCI 100 or the GFCI 200 described below.

The wireless power transmitter 12 may include a transmitter controller 40 configured to control the power transmitted by the wireless power transmitter 12 and the wireless power receiver 14 may also include a receiver controller 42 configured to control the power received by the wireless power receiver 14. The wireless power transmitter 12 and the wireless power receiver 14 may also each include a transceiver 44 configured to provide a wireless communication link 46 between the transmitter controller 40 and the receiver controller 42. Examples of wireless energy transfer systems incorporating tuned resonant circuits are well known to those skilled in the art may be found, for example in U.S. Pat. No. 8,304,935 granted to Karalis et al.

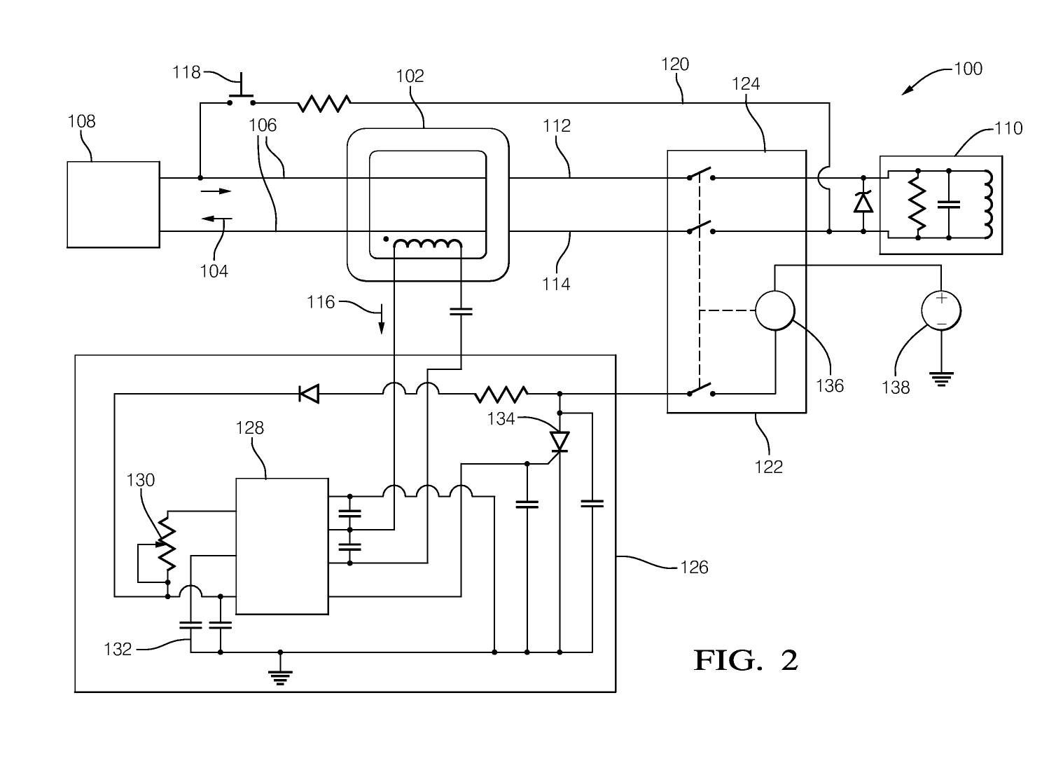

FIG. 2 illustrates a non-limiting example of a GFCI 100 in accordance with one embodiment of this invention. GFCI 100 described herein may be used with the wireless power transmitter 12 or the wireless power receiver 14 described above and shown in FIG. 1. GFCI 100 includes a sense coil 102 configured to determine whether a current 104 flowing in a power circuit 106 coupled between a power source 108 and a load 110 is balanced between a hot conductor 112 and a neutral conductor 114 of the power circuit 106. Both the unshielded hot conductor 112 and the unshielded neutral conductor 114 are routed through the sense coil 102. Without subscribing to a particular theory of operation, when the current 104 flowing through the hot conductor 112 and the neutral conductor 114 are unbalanced, because a portion of the current 104 is flowing through an undesired conductive path from the hot conductor 112 to ground, an imbalance in current 104 flowing in the hot conductor 112 and the neutral conductor 114 perturbs the flux cancellation and induces a current 116 in the sense coil 102 that is proportional to this imbalance. However, when the current 104 flowing through the hot conductor 112 and the neutral conductor 114 are balanced, the current 116 will not be induced in the sense coil 102. The design and construction of sense coils for GFCIs are well known to those skilled in the art. GFCI 100 may also include a second sense coil (not shown) configured to detect ground faults between the neutral conductor 114 and ground. However, in applications such as the wireless power transmitter 12 and wireless power receiver 14 wherein both the hot conductor 112 and the neutral conductor 114 are isolated from ground, only a single sense coil 102 is needed to detect a ground fault from either the hot conductor 112 or the neutral conductor 114. GFCI 100 may also include a momentary contact switch 118 that shorts the hot conductor 112 to the neutral conductor 114 routing a portion of the current 104 through a conductor 120 that does not pass through the sense coil 102, thereby unbalancing the current 104 passing through the sense coil 102 and inducing a current 116 in the sense coil 102 to test the operation of the GFCI 100.

In the example of the wireless power transmitter 12 of FIG. 1, the load 110 is source resonator 20 that contains a tuned resonant circuit made up of resistive, capacitive, and inductive elements. Alternatively, as in the example of the wireless power receiver 14 of FIG. 1, the power source 108 is a capture resonator 28 that contains a tuned resonant circuit made up of resistive, capacitive, and inductive elements.

GFCI 100 also includes a switching device 122 coupled to the power circuit 106 and configured to disconnect the power source 108 from the load 110. The switching device 122 may include mechanical contacts 124 that open to disconnect the power source 108 from the load 110 when commanded by an electrical signal. In the example illustrated in FIG. 2, the switching device 122 includes a circuit breaker that opens when it is tripped and remains open until it is manually reset. Alternatively, the switching device 122 may be a solid state electronic switching device, such as a metal-oxide-semiconductor field effect transistor (MOSFET).

GFCI 100 further includes a controller 126 in communication with the sense coil 102 and the switching device 122 and configured to control the switching device 122 based on the current 104 flowing in the power circuit 106 as detected by the sense coil 102. The controller 126 includes sense circuitry that monitors the output of sense coil 102 and generates a trip signal to the switching device 122 to disconnect the load 110 from the power source 108 when the current 116 in the sense coil 102 exceeds a designated threshold, typically 5 milliamperes (mA). The controller 126 may include an application specific integrated circuit (ASIC) 128 such as Model Number LM1851 manufactured by Texas Instruments of Dallas, Tex. Without subscribing to any particular theory of operation, the ASIC 128 may include a comparator (not shown), amplifier (not shown), current sources (not shown) and a latch (not shown) that senses current 116 in the sense coil 102 at a level set by an external potentiometer 130, and reacts in a time interval set by an external timing capacitor 132. When a ground fault is detected, the ASIC 128 turns on a silicon controlled rectifier (SCR) 134 which energizes a trip solenoid 136 in the switching device 122 and opens all of the contacts 124 of the switching device 122. Alternatively or additionally, the controller 126 may include a processor (not shown) such as a microprocessor or other control circuitry as should be evident to those skilled in the art. The controller 126 may also include analog to digital convertor circuitry and digital to analog convertor circuitry to interface with the sense coil 102 and switching device 122. The controller 126 may also include memory (not shown), including non-volatile memory, such as electrically erasable programmable read-only memory (EEPROM) for storing one or more routines, thresholds and captured data. The one or more routines may be executed by the processor to perform steps for determining a current 116 flowing in the sense coil 102 and opening the switching device 122.

GFCI 100 additionally includes a GFCI power supply 138 that is electrically coupled to the switching device 122 and provides electrical power to the switching device 122. The GFCI power supply 138 may additionally be electrically coupled to the controller 126 and provide electrical power to the controller 126. The GFCI power supply 138 is electrically separate and electrically isolated from the power circuit 106. As used herein, electrically separate and electrically isolated from the power circuit 106 means that none of the current 104 flowing through the power circuit 106 flows through the GFCI power supply 138 or the switching device 122. The GFCI power supply 138 may be a direct current power supply that rectifies electrical power from an alternating current power source, such as the power source 18 shown in FIG. 1 and coverts the rectified current to a desired voltage. Alternatively, the GFCI power supply 138 may be a direct current power supply that draws electrical power from a direct current power source, such as the battery 38 shown in FIG. 1, and coverts the direct current to the desired voltage.

When GFCI 100 detects a ground fault current 116 and disconnects the power source 108 from the load 110, GFCI 100 remains disconnected until manually reset to reconnect the load 110 and power source 108. If GFCI 100 is used in a wireless vehicle charging system, such as the wireless power transfer system 10 shown in FIG. 1, it may require several hours to recharge a vehicle battery 38. If a ground fault occurs that trips GFCI 48 or GFCI 50, the vehicle operator may return to a vehicle having a battery 38 that is not fully charged. If the ground fault condition was transient condition, vehicle charging could continue once the ground fault condition is cleared until the battery 38 is fully charged if GFCI 48 or GFCI 50 is automatically reset after the ground fault condition is cleared. GFCI 200 described herein is capable of being automatically reset after a ground fault condition occurs.

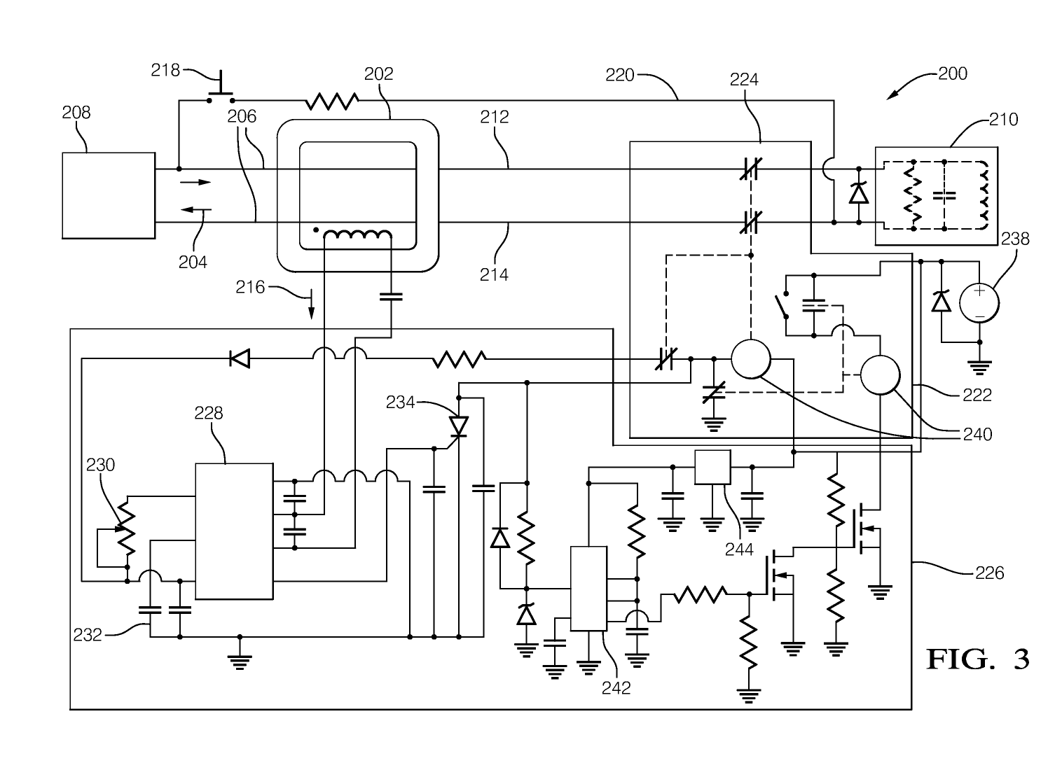

FIG. 3 illustrates another non-limiting example of a GFCI 200. GFCI 200 described herein may be used with the wireless power transmitter 12 or the wireless power receiver 14 described above and shown in FIG. 1. The elements shown in FIG. 3 wherein the last two digits of the reference number correspond to the last two digits of the embodiment shown in FIG. 2 perform similar functions as in the embodiment of FIG. 2 described above. The switching device 222 includes an electrically resettable relay 240, such as a Model MJN3C-DC24 available from OMRON Corporation of Novi, Mich. rather than a circuit breaker as shown in the switching device 122 of FIG. 2. The controller 226 is configured to control the relay 240 to reconnect the power source 208 to the load 210 after a ground fault condition was detected. The controller 226 includes a timer 242 so that the controller 226 can command the switching device 222 to reconnect the power source 208 to the load 210 after a time period elapses to determine whether the ground fault condition persists. If the controller 226 determines that the ground fault does indeed still exist, the controller 226 will command the switching device 222 to again disconnect the load 210 from the power source 208. Otherwise, the switching device 222 will maintain the connection between the load 210 and the power source 208. The controller 226 may be configured to suspend attempting to reconnect the load 210 and power source 208 if the ground fault persists for a predetermined number of reconnection attempts or for a predetermined time period. The controller 226 may also be configured to vary the time period between connection attempts. For example, the controller 226 may try to reconnect every 10 seconds for several attempts, then every 60 seconds for several attempts, followed by every 5 minutes. The timer 242 may be an integrated circuit timer 242, such as Model MC 1455 available from ON Semiconductor of Huntsville, Ala. The controller 226 may further include a timer power supply IC 244, such as Model LM7812 available from Fairchild Semiconductor of San Jose, Calif. to provide proper voltage to the timer IC 242 if the voltage supplied by the GFCI power supply 238 is incompatible with the timer IC 242.

While the GFCI 100, 200 shown in the above examples is applied to a wireless energy transfer system, the GFCI 100, 200 described herein may also be used in other applications where it is desirable to isolate the switching device 122, 222 and/or the controller 126, 226 from a power circuit 106, 206 that is monitored for ground faults.

Accordingly, a GFCI (100, 200), a wireless power transmitter (12) including a GFCI (100, 200), and a wireless power receiver (14) including a GFCI (100, 200) is provided. The GFCI (100, 200) has a power supply (138, 238) for the switching device (122, 222) that is electrically isolated and electrically separate from the power circuit (106, 206) connected to the GFCI (100, 200) for which the GFCI (100, 200) is configured to detect an undesired current flowing to ground. Isolating the power supply (138, 238) for the switching device (122, 222) prevents an inductive element in the switching device (122, 222) from unbalancing a tuned resonant circuit, such as the source resonator (20) in the wireless power transmitter (12) or the capture resonator (28) in the wireless power receiver (14). The GFCI (200) may periodically reconnect the load (2100 and the power source (208) to determine whether the ground fault condition has cleared.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. An electrical ground fault circuit interrupter (GFCI) device, comprising:
a sense coil configured to determine a current flow in an electrically conductive power circuit coupled between a power source and a load;
a switching device coupled to the power circuit and configured to disconnect the power source from the load;
a controller in communication with said sense coil and said switching device and configured to control said switching device based on the current flow in the power circuit; and
an electrical power supply coupled to said switching device, wherein the power supply is electrically separate and electrically isolated from the power circuit.

2. The GFCI device of claim 1, wherein the power source is a tuned resonant circuit.

3. The GFCI device of claim 2, wherein the tuned resonant circuit is a capture resonator.

4. The GFCI device of claim 1, wherein the load is a tuned resonant circuit.

5. The GFCI device of claim 4, wherein the tuned resonant circuit is a source resonator.

6. The GFCI device of claim 1, wherein said controller is configured to control said switching device to reconnect the power source to the load after said switching device disconnects the power source from the load.

7. A wireless power transmitter, comprising:
a power source;
a source resonator;
an electrically conductive power circuit coupled between said power source and said source resonator; and
a GFCI device, including
a sense coil configured to determine a current flow in said power circuit,
a switching device coupled to said power circuit and configured to disconnect said power source from said source resonator,
a controller in communication with the sense coil and the switching device and configured to control the switching device based on the current flow in said power circuit, and
an electrical power supply coupled to the switching device, wherein the power supply is electrically separate and electrically isolated from said power circuit.

8. The wireless power transmitter of claim 7, wherein the source resonator is a tuned resonant circuit.

9. The wireless power transmitter of claim 7, wherein said controller is configured to control said switching device to reconnect the power source to the source resonator after said switching device disconnects the power source from the source resonator.

10. A wireless power receiver, comprising:
a capture resonator;
an electrical storage device;
an electrically conductive power circuit coupled between said capture resonator and said storage device; and
a GFCI device, including
a sense coil configured to determine a current flow in said power circuit,
a switching device coupled to said power circuit and configured to disconnect said capture resonator from said storage device,
a controller in communication with the sense coil and the switching device and configured to control the switching device based on the current flow in said power circuit, and
an electrical power supply coupled to the switching device, wherein the power supply is electrically separate and electrically isolated from said power circuit.

11. The wireless power receiver of claim 10, wherein the capture resonator is a tuned resonant circuit.

12. The wireless power receiver of claim 10, wherein said controller is configured to control said switching device to reconnect the capture resonator to said storage device after said switching device disconnects the capture resonator from said storage device.
